(19) United States
(12) Patent Application Publication
(10) Pub. No.: US 2024/0015049 A1
(43) Pub. Date: Jan. 11, 2024

(54) TRANSFER DEVICE, TRANSFER METHOD, AND TRANSFER PROGRAM

(71) Applicant: Nippon Telegraph and Telephone Corporation, Tokyo (JP)

(72) Inventors: Yuhei HAYASHI, Musashino-shi, Tokyo (JP); Hiroshi OSAWA, Musashino-shi, Tokyo (JP); Hiroki INOUE, Musashino-shi, Tokyo (JP)

(21) Appl. No.: 18/029,507

(22) PCT Filed: Sep. 30, 2020
(86) PCT No.: PCT/JP2020/037274

§ 371 Date: Mar. 30, 2023

(51) Int. Cl. H04L 12/46; H04L 45/74

(52) U.S. Cl. CPC H04L 12/4633; H04L 45/74

(57) ABSTRACT

When the deletion unit deletes the outer header of the encapsulated packet, the outer header and a field containing information of the outer header are provided in the packet. In addition, when re-encapsulating a received packet, the addition unit adds an outer header to the packet by using information of the outer header extracted from the field.

### TECHNICAL FIELD

The present invention relates to a transfer device, a transfer method, and a transfer program.

### BACKGROUND ART

Conventionally, from the viewpoint of economic efficiency, a technology is expected in which a network service function (NSF) that analyzes an L3-L4 header and an L7 payload of a packet and performs some processing is intensively deployed in a network instead of being distributed, and then communication is transferred and NSF application is performed.

On the other hand, in the network using the encapsulating technology for transfer, there is a case where the NSF cannot be intensively deployed, such as a case where a capsule header is assigned to a packet at an aggregation point and the NSF does not support the header. Therefore, a technology for removing and re-encapsulating the capsule header has been proposed (refer to Patent Literature 1 and 2 and Non Patent Literature 1 to 5).

### CITATION LIST

### Patent Literature

Patent Literature 1: JP 2017-038179 A
Patent Literature 2: JP 2019-097069 A

### Non Patent Literature

Non Patent Literature 1: FD.io VPP, “SRv6 endpoint to SR-unaware appliance via static proxy (End.AS), “Towards Deep Learning Models Resistant to Adversarial Attacks”, [online], [retrieved on Sep. 1, 2020], Internet <URL:https://docs.fd.io/vpp/18.04/srv6 as plugin doc.html>
Non Patent Literature 2: Lily Guo, “Analysis of Service Function Chaining for Carrier Grade Networks,” Technical report, NS2014-256, Vol. 114, No. 477, pp. 463-468.
Non Patent Literature 3: Yukito Ueno, “SRv6 Tagging Proxy”, [online], arXiv:1901.08573v3 [cs.LG], June, 2019, [retrieved on Sep. 1, 2020], Internet <URL:https://datatracker.ietf.org/meeting/106/materials/sli des-106-spring-sessa-srv6-tagging-proxy-00.pdf>
Non Patent Literature 4: A. Mayer, S. Salsano, P. L. Ventre, A. Abdelsalam, L. Chiaraviglio and C. Filsfils, “An Efficient Linux Kernel Implementation of Service Function Chaining for legacy VNFs based on IPv6 Segment Routing”, 2019 IEEE Conference on Network Softwarization (NetSoft), Paris, France, 2019, pp. 333-341, doi:10.1109/NETSOFT.2019.8806652
Non Patent Literature 5: FD.io VPP, “SRv6 endpoint to SR-unaware appliance via dynamic proxy (End.AD)”, [online], [retrieved on Sep. 1, 2020], Internet <URL:https://docs.fd.io/vpp/18.04/srv6_ad_plugin doc.html>

### SUMMARY OF INVENTION

### Technical Problem

However, in the related art, it may be difficult to perform processing such as analysis of packets in the aggregated NSF at low cost. For example, it may be necessary to associate the outer header and the inner header of the capsule in advance. Alternatively, at the time of re-encapsulation, in a case where the inner packet is a local address, a reassignment error of the outer header may occur. Alternatively, there is a case where a retrieval key of the outer header is assigned to a Tos value or the like of a vlan header or an IP packet to affect a service.

The present invention has been made in view of the above, and an object thereof is to perform processing such as packet analysis by aggregated NSF at low cost.

### Solution to Problem

In order to solve the above-described problems and achieve the object, according to the present invention, there is provided a transfer device including: a deletion unit that provides an outer header and a field containing information of the outer header in an encapsulated packet when deleting the outer header of the packet; and an addition unit that adds the outer header to a received packet by using information of the outer header extracted from the field when the packet is re-encapsulated.

### Advantageous Effects of Invention

According to the present invention, processing such as packet analysis can be performed by the aggregated NSF at low cost.

### BRIEF DESCRIPTION OF DRAWINGS

FIG. 1 is a diagram for explaining an outline of a transfer device.

FIG. 2 is a schematic diagram illustrating, as an example, a schematic configuration of the transfer device.

FIG. 3 is a diagram for explaining of processing of the transfer device of a first embodiment.

FIG. 4 is a diagram for explaining the processing of the transfer device of the first embodiment.

FIG. 5 is a diagram for explaining of processing of a transfer device of a second embodiment.

FIG. 6 is a diagram for explaining of the processing of the transfer device of the second embodiment.

FIG. 7 is a diagram for explaining of the processing of the transfer device of the second embodiment.

FIG. 8 is a diagram for explaining processing of a transfer device of a third embodiment.

FIG. 9 is a diagram for explaining the processing of the transfer device of the third embodiment.

FIG. 10 is a sequence diagram illustrating a transfer processing procedure.

FIG. 11 is a diagram for explaining an effect of transfer processing.

FIG. 12 is a diagram illustrating, as an example, a computer that executes a transfer program.

### DESCRIPTION OF EMBODIMENTS

Hereinafter, an embodiment of the present invention will be described in detail with reference to the drawings. Note that the present invention is not limited by this embodiment. Further, the same portions are denoted by the same reference signs in the description of the drawings.

### [Outline of Transfer Device]

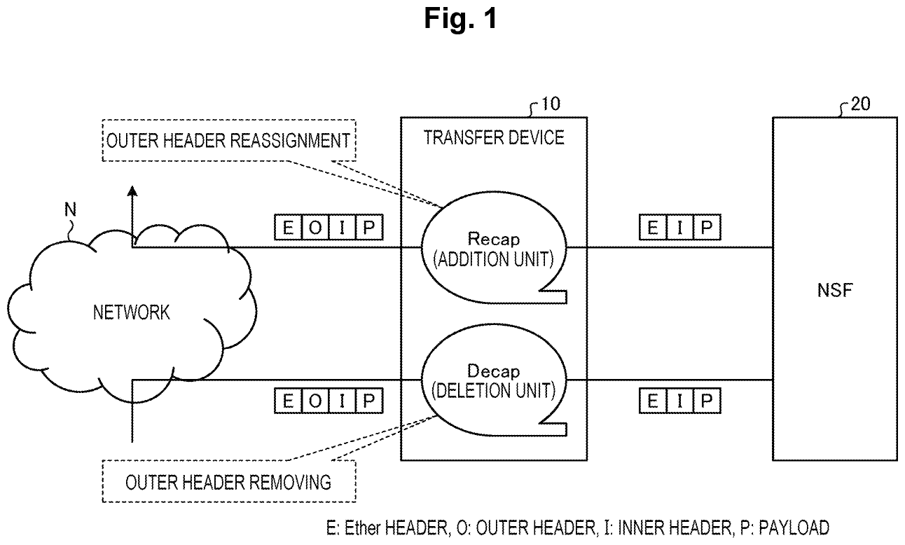

FIG. 1 is a diagram for explaining an outline of a transfer device. As illustrated in FIG. 1, when receiving an encapsulated packet from another network device via a network N, a transfer device 10 of the present embodiment deletes the capsule header (outer header) and transfers the packet to the NSF 20.

At that time, the transfer device 10 includes an outer header and a field including the information of the outer header in the packet without caching the packet or the outer header, for example. Alternatively, information associating the packet with information on an inner packet is stored in a storage unit 14. Alternatively, information associating the outer header with the information of the inner packet is stored in the storage unit 14.

An NSF 20 analyzes an L3-L4 header and a L7 payload of the packet (inner packet), performs some processing, and returns the packet to the transfer device 10.

When a packet is received from the NSF 20, the transfer device 10 performs re-encapsulation of reassigning an outer header using information of the outer header extracted from the above field, and transfers the packet to another network device via the network N. Alternatively, the transfer device 10 reassigns the outer head to the packet extracted from the storage unit by using the information of the associated inner packet, and transfers the packet to another network device via the network N. Alternatively, the transfer device 10 reassigns the outer header associated with the information of the inner packet extracted from the storage unit, and transfers the outer header to another network device via the network N.

### [Configuration of Transfer Device]

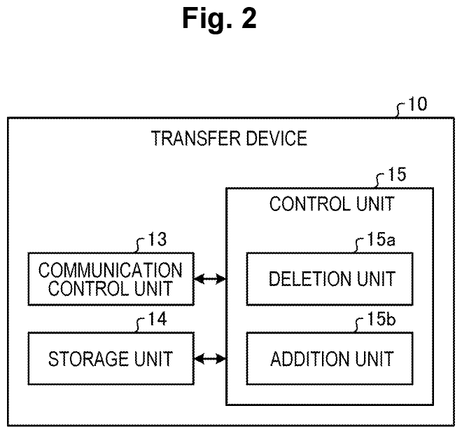

FIG. 2 is a schematic diagram illustrating, as an example, a schematic configuration of the transfer device. As illustrated in FIG. 2 as an example, the transfer device 10 is realized by a general-purpose computer such as a personal computer and includes a communication control unit 13, a storage unit 14, and a control unit 15.

The communication control unit 13 is realized by a network interface card (NIC) or the like and controls communication between an external device such as a server and the control unit 15 via a network. For example, the communication control unit 13 controls communication between the control unit 15 and a management device or the like that manages data to be transferred.

The storage unit 14 is realized by a semiconductor memory element such as a random access memory (RAM) or a flash memory or a storage device such as a hard disk or an optical disc and stores the packet or the outer header used in transfer processing, which will be described later. Note that the storage unit 14 may be configured to communicate with the control unit 15 via the communication control unit 13.

The control unit 15 is realized by using a central processing unit (CPU), a network processor (NP), a field programmable gate array (FPGA), or the like, and executes a processing program stored in a memory. As a result, as illustrated in FIG. 2, the control unit 15 functions as a deletion unit 15a and an addition unit 15b. Note that each of these functional units may be implemented in different pieces of hardware. Moreover, the control unit 15 may include other functional units.

### First Embodiment

In the transfer device 10 of the first embodiment, the deletion unit 15a provides the outer header and a field containing information of the outer header in the packet when deleting the outer header of the encapsulated packet. This field is specifically a proxy header or a Trailer to be described later. In addition, in this case, the information of the outer header includes the length of the outer header and the protocol type.

In addition, when re-encapsulating the received packet, the addition unit 15b adds an outer header to the packet by using information of the outer header extracted from the above field. As a result, the transfer device 10 can transfer the packet to the aggregated NSF at low cost without requiring a processing load of cache search and a cache memory.

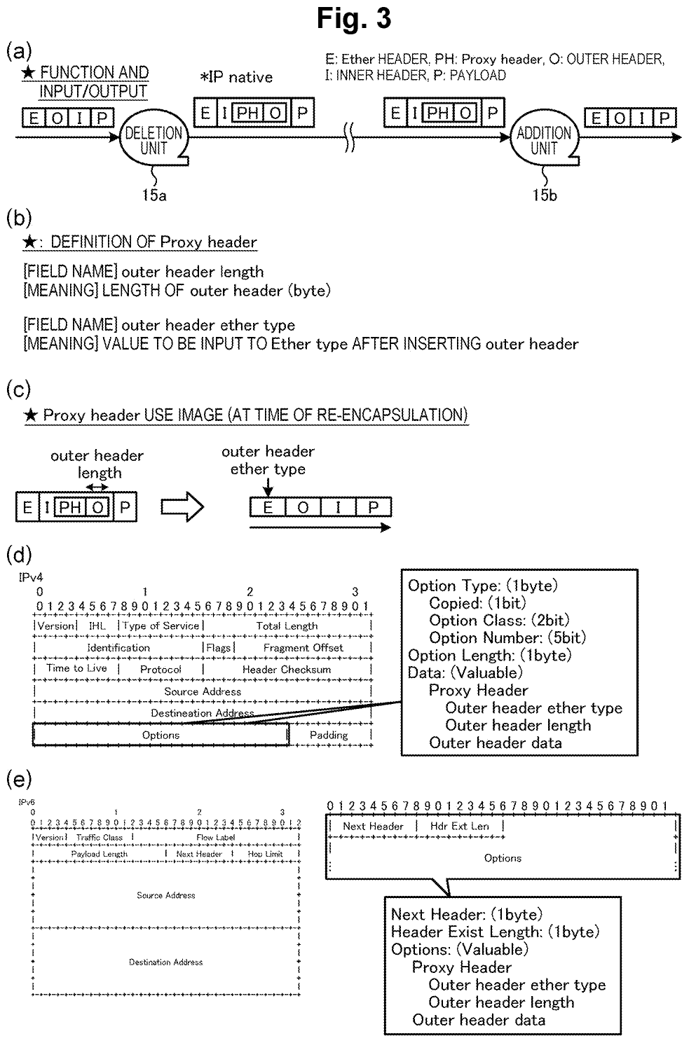

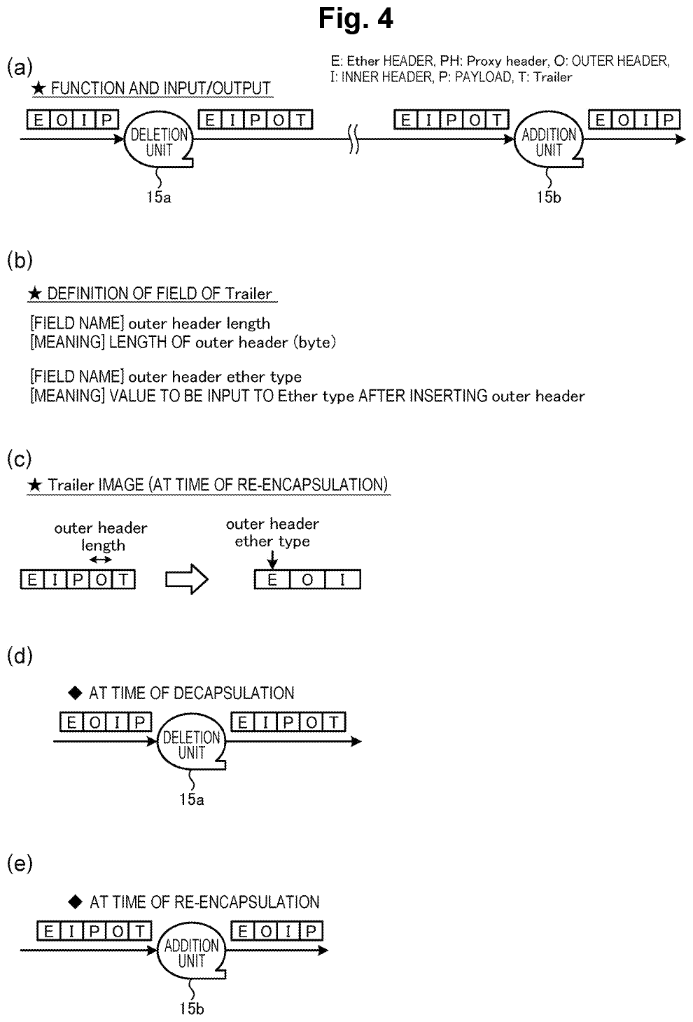

Here, FIGS. 3 and 4 are diagrams for explaining the processing of the transfer device according to the first embodiment. For example, as illustrated in FIG. 3, the deletion unit 15a incorporates the proxy header into the inner packet. Specifically, the deletion unit 15a includes the length of the outer header and the protocol type in the proxy header defined as illustrated in FIG. 3(b). In addition, as illustrated in FIGS. 3(a) and 3(c), the deletion unit 15a incorporates the proxy header and the deleted outer header into the header (inner header) of the inner packet, and transfers the header to the NSF 20 via the communication control unit 13.

In this case, as illustrated in FIGS. 3(a) and 3(c), the addition unit 15b adds an outer header to the packet from which the proxy header and the outer header have been deleted using the proxy header and the outer header of the packet received from the NSF 20 via the communication control unit 13, and transfers the packet to another network device via the communication control unit 13.

Here, the protocol type is, for example, IPv4 or IPv6. The deletion unit 15a sets a proxy header according to EtherHeader indicating the protocol type of the received packet. Specifically, when the protocol type is IPv4, the deletion unit 15a inserts the proxy header and the outer header into the data portion of the option area of the inner packet as illustrated in FIG. 3(d). Thereafter, the deletion unit 15a performs decapsulation for deleting the outer header. In addition, the deletion unit 15a obtains packet consistency by checksum calculation.

In this case, the addition unit 15b performs re-encapsulation to add the outer header using the proxy header and the outer header of the option area of the inner packet, and deletes the option area. In addition, the addition unit 15b obtains packet consistency by checksum calculation.

When the protocol type is IPv6, the deletion unit inserts the proxy header and the outer header into the option area of the extension header as illustrated in FIG. 3(e). Thereafter, the deletion unit 15a performs decapsulation for deleting the outer header. In addition, the deletion unit 15a obtains packet consistency by checksum calculation.

In this case, the addition unit 15b performs re-encapsulation to add the outer header using the proxy header and the outer header of the extension header of the inner packet, and deletes the extension header. In addition, the addition unit 15b obtains packet consistency by checksum calculation. As a result, the transfer device can easily perform re-encapsulation without affecting payload analysis.

Alternatively, as illustrated in FIG. 4, the deletion unit 15a adds a Trailer to be described later to the end of the packet. Specifically, the deletion unit 15a includes the length of the outer header and the protocol type in the Trailer defined as illustrated in FIG. 4(b). In addition, as illustrated in FIGS. 4(a), 4(c), and 4(d), the deletion unit 15a incorporates Trailer and the deleted outer header at the end of the inner packet, and transfers the inner packet to the NSF 20 via the communication control unit 13.

In this case, as illustrated in FIGS. 4(a), 4(c), and 4(e), the addition unit 15b adds an outer header to the packet from which the Trailer and the outer header have been deleted using the Trailer and the outer header of the packet received from the NSF 20 via the communication control unit 13, and transfers the packet to another network device via the communication control unit 13. As a result, the transfer device 10 can perform re-encapsulation without registering resources in the IRNA that manages Internet resources.

### Second Embodiment

In the transfer device 10 of the second embodiment, the deletion unit 15a causes the storage unit 14 to store information associating the packet with information of the inner packet when deleting the outer header of the encapsulated packet. In this case, when re-encapsulating the received packet, the addition unit 15b adds the outer header to the packet extracted from the storage unit 14 by using the information of the associated inner packet.

In this case, the information of the inner packet is any one of the 5-tuple, all of the hash values of the inner packet, and the hash value of a predetermined bit string in the inner packet.

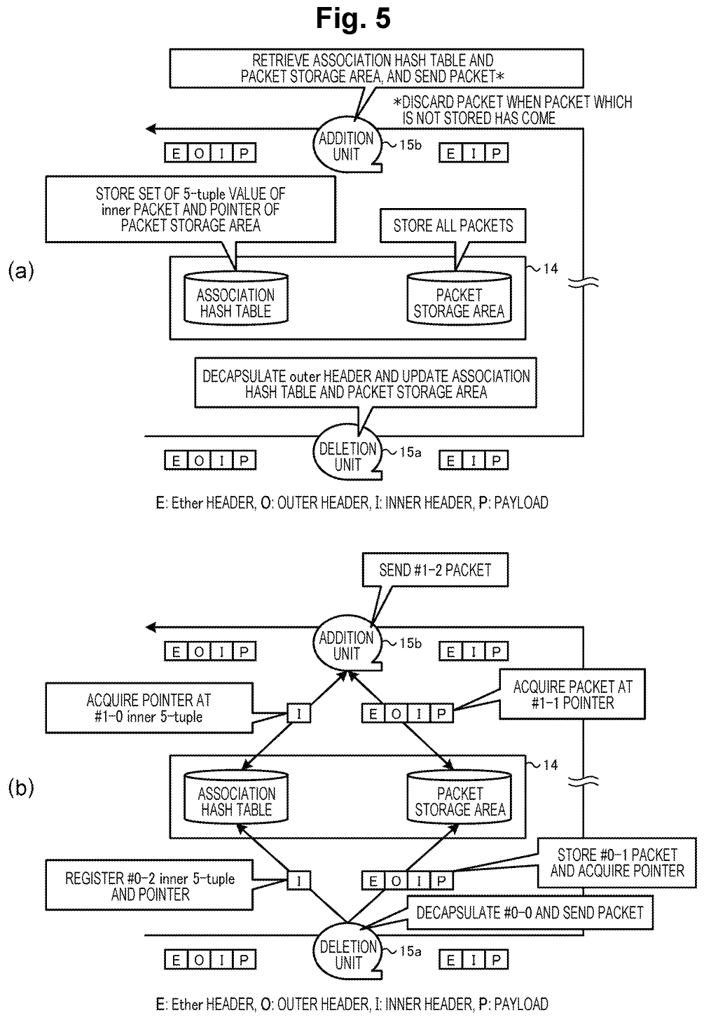

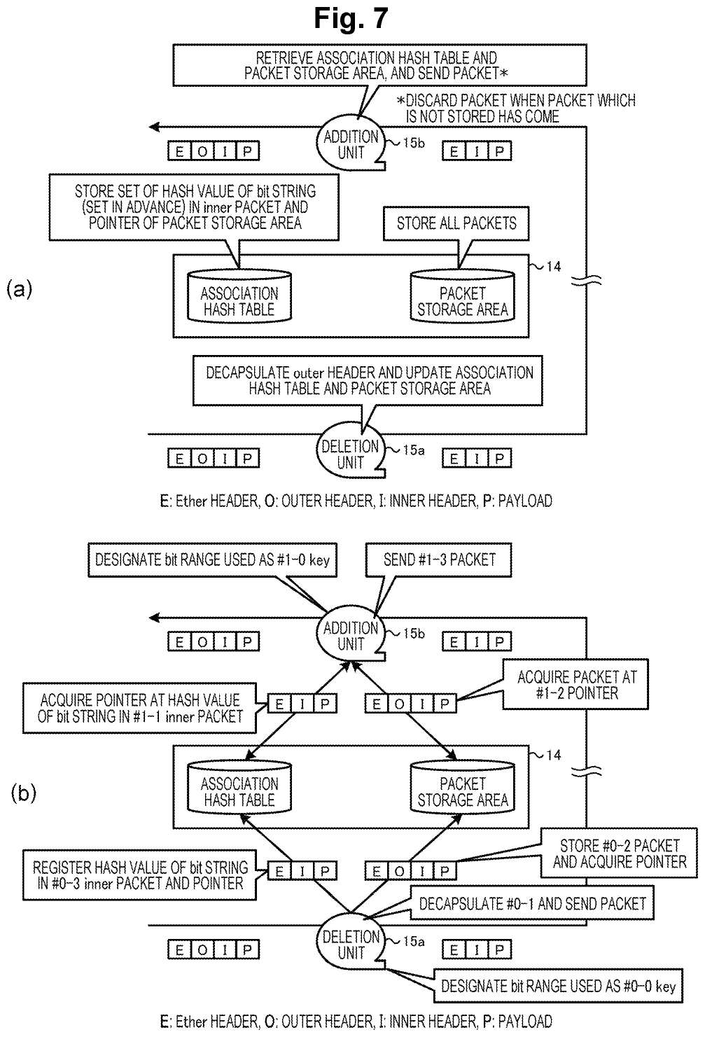

Here, FIGS. 5 and 7 are diagrams for explaining the processing of the transfer device according to the second embodiment. For example, as illustrated in FIG. 5, the deletion unit 15a associates the packet with the 5-tuple of the inner packet when deleting the outer header of the encapsulated packet. Specifically, as illustrated in FIG. 5(a), the deletion unit 15a stores the packet in the packet storage area of the storage unit 14, and stores an association hash table that associates the pointer of the packet storage area with the 5-tuple of the inner packet in the storage unit 14.

Specifically, as illustrated in FIG. 5(b), the deletion unit 15a stores all of the packets before the outer header is deleted in the packet storage area, and acquires the pointer. In addition, the deletion unit 15a registers the 5-tuple of the inner packet and the acquired pointer in the association hash table. In addition, the deletion unit 15a transfers the inner packet from which the outer header has been deleted to the NSF via the communication control unit 13.

In this case, when re-encapsulating the received packet, the addition unit 15b retrieves the packet storage area and the association hash table as illustrated in FIG. 5(a), and acquires a packet corresponding to the 5-tuple of the received packet.

Specifically, as illustrated in FIG. 5(b), a pointer corresponding to 5tuple of the received packet is acquired from the association hash table, and the packet acquired from the packet storage area by the acquired pointer is transmitted to another network device via the communication control unit 13. When the received packet is not stored in storage unit 14, the addition unit 15b discards the packet.

By associating the packet with the 5-tuple of the inner packet in this manner, the transfer device 10 can delete the processing cost of re-encapsulation.

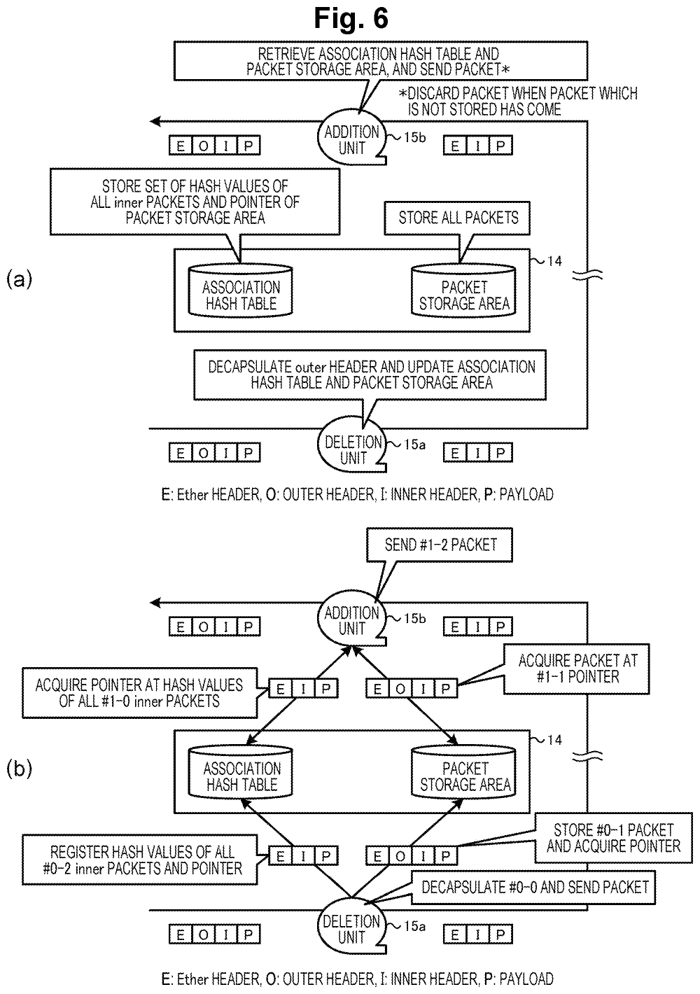

For example, as illustrated in FIG. 6, the deletion unit 15a associates the packet with the hash value of the inner packet when deleting the outer header of the encapsulated packet. Specifically, as illustrated in FIG. 6(a), the deletion unit 15a stores the packet in the packet storage area of the storage unit 14, and stores an association hash table that associates the pointer of the packet storage area with the hash value of the inner packet in the storage unit 14.

Specifically, as illustrated in FIG. 6(b), the deletion unit 15a stores all of the packets before the outer header is deleted in the packet storage area, and acquires the pointer. In addition, the deletion unit 15a registers the hash value of the inner packet and the acquired pointer in the association hash table. In addition, the deletion unit 15a transfers the inner packet from which the outer header has been deleted to the NSF via the communication control unit 13.

In this case, when re-encapsulating the received packet, the addition unit 15b retrieves the packet storage area and the association hash table as illustrated in FIG. 6(a), and acquires a packet corresponding to the hash value of the received packet.

Specifically, as illustrated in FIG. 6(b), a pointer corresponding to hash value of the received packet is acquired from the association hash table, and the packet acquired from the packet storage area by the acquired pointer is transmitted to another network device via the communication control unit 13. When the received packet is not stored in storage unit 14, the addition unit 15b discards the packet.

By associating the packet with the hash value of the inner packet in this manner, the transfer device 10 can reduce the reassignment error of the outer header.

For example, as illustrated in FIG. 7, the deletion unit 15a associates the packet with the hash value of a predetermined bit string in the inner packet when deleting the outer header of the encapsulated packet. Specifically, as illustrated in FIG. 7(a), the deletion unit 15a stores the packet in the packet storage area of the storage unit 14, and stores an association hash table that associates the pointer of the packet storage area with the hash value of a predetermined bit string in the inner packet in the storage unit 14.

Specifically, as illustrated in FIG. 7(b), the deletion unit 15a stores all of the packets before the outer header is deleted in the packet storage area, and acquires the pointer. In addition, the deletion unit 15a registers the hash value of the designated bit string in the inner packet and the acquired pointer in the association hash table. In addition, the deletion unit 15a transfers the inner packet from which the outer header has been deleted to the NSF via the communication control unit 13.

In this case, when re-encapsulating the received packet, the addition unit 15b retrieves the packet storage area and the association hash table as illustrated in FIG. 7(a), and acquires a packet corresponding to the hash value of a predetermined bit string in the received packet.

Specifically, as illustrated in FIG. 7(b), a pointer corresponding to hash value of the designated bit string in the received packet is acquired from the association hash table, and the packet acquired from the packet storage area by the acquired pointer is transmitted to another network device via the communication control unit 13. When the received packet is not stored in storage unit 14, the addition unit 15b discards the packet.

By associating the packet with the hash value of a predetermined bit string in the inner packet in this manner, the transfer device 10 can reduce the reassignment error ratio of the outer header.

### Third Embodiment

In the transfer device 10 of the third embodiment, the deletion unit 15a causes the storage unit 14 to store the information associating the outer header with information of the inner packet when deleting the outer header of the encapsulated packet. In this case, when re-encapsulating the received packet, the addition unit 15b adds the outer header associated with the information of the inner packet extracted from the storage unit 14.

In this case, the information of the inner packet is any one of the hash value of the inner packet, and the hash value of a predetermined bit string in the inner packet.

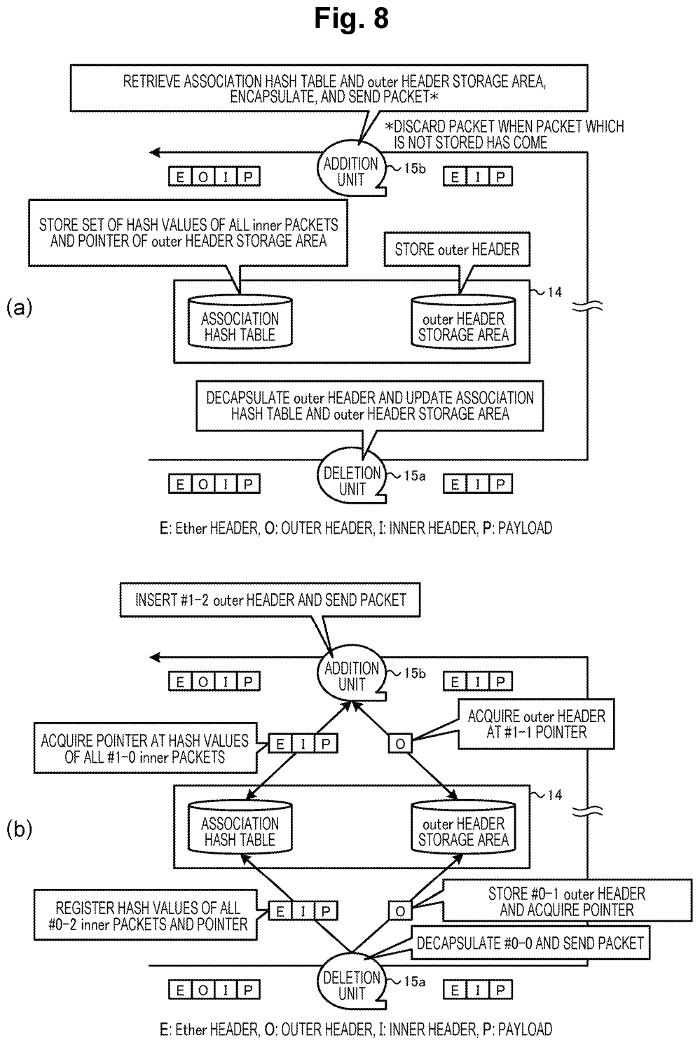

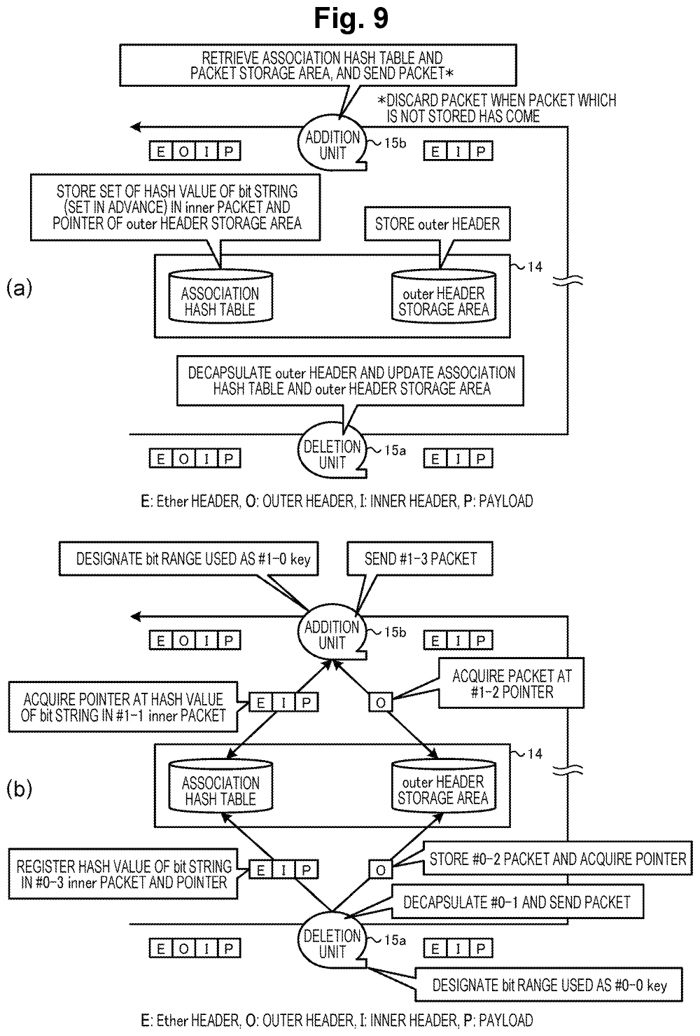

Here, FIGS. 8 and 9 are diagrams for explaining the processing of the transfer device according to the third embodiment. For example, as illustrated in FIG. 8, the deletion unit 15a associates the outer header with the hash value of the inner packet when deleting the outer header of the encapsulated packet. Specifically, as illustrated in FIG. 8(a), the deletion unit 15a stores the outer header in the outer header storage area of the storage unit 14, and stores an association hash table associating the pointer of the outer header storage area with the hash value of the inner packet in the storage unit 14.

Specifically, as illustrated in FIG. 8(b), the deletion unit 15a stores the outer header in the outer header storage area and acquires the pointer. In addition, the deletion unit 15a registers the hash value of the inner packet and the acquired pointer in the association hash table. In addition, the deletion unit 15a transfers the inner packet from which the outer header has been deleted to the NSF via the communication control unit 13.

In this case, when re-encapsulating the received packet, the addition unit 15b retrieves the outer header storage area and the association hash table as illustrated in FIG. 8(a), and acquires an outer header corresponding to the hash value of the received packet.

Specifically, as illustrated in FIG. 8(b), the pointer corresponding to the hash value of the received packet is acquired from the association hash table, and the outer header is acquired from the outer header storage area by the acquired pointer. Then, the addition unit 15b transmits the packet to which the outer header is added to another network device via the communication control unit 13. When the outer header of the received packet is not stored in storage unit 14, the addition unit 15b discards the packet.

By associating the outer header with the hash value of the inner packet in this manner, the transfer device 10 can reduce the memory consumption.

As illustrated in FIG. 9, the deletion unit 15a associates the outer header with a hash value of a predetermined bit string in the inner packet when deleting the outer header of the encapsulated packet. Specifically, as illustrated in FIG. 9(a), the deletion unit 15a stores the outer header in the outer header storage area of the storage unit 14, and stores an association hash table associating the pointer of the outer header storage area with the hash value of a predetermined bit string in the inner packet in the storage unit 14.

Specifically, as illustrated in FIG. 9(b), the deletion unit 15a stores the outer header in the outer header storage area and acquires the pointer. In addition, the deletion unit 15a registers the hash value of the designated bit string in the inner packet and the acquired pointer in the association hash table. In addition, the deletion unit 15a transfers the inner packet from which the outer header has been deleted to the NSF via the communication control unit 13.

In this case, when re-encapsulating the received packet, the addition unit 15b retrieves the outer header storage area and the association hash table as illustrated in FIG. 9(a), and acquires an outer header corresponding to the hash value of a designated predetermined bit string in the received packet.

Specifically, as illustrated in FIG. 9(b), the pointer corresponding to the hash value of the designated bit string in received packet is acquired from the association hash table, and the outer header is acquired from the outer header storage area by the acquired pointer. Then, the addition unit 15b transmits the packet to which the outer header is added to another network device via the communication control unit 13. When the received packet is not stored in storage unit 14, the addition unit 15b discards the packet.

By associating the outer header with the hash value of a predetermined bit string in the inner packet in this manner, the transfer device 10 can reduce the reassignment error of the outer header.

### [Transfer Processing]

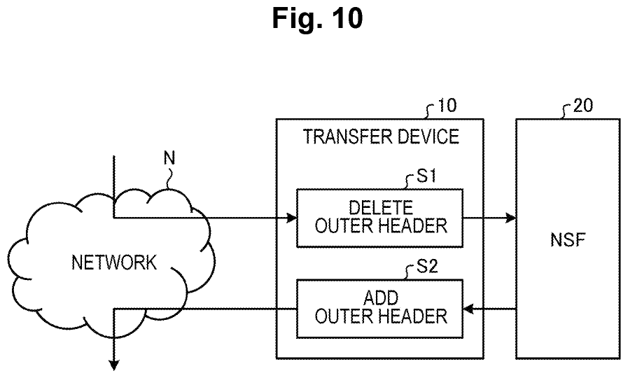

Next, transfer processing performed by the transfer device 10 according to the present embodiment will be described with reference to FIG. 10. FIG. 10 is a sequence diagram illustrating a transfer processing procedure. The sequence of FIG. 10 is started at a timing when the transfer device 10 receives a packet.

First, when the transfer device 10 receives an encapsulated packet from another network device via the network N, the deletion unit 15a deletes the outer header of the encapsulated packet and transfers the packet to the NSF (step S1).

At that time, the deletion unit 15a includes the outer header and a field including information of the outer header at the end of the inner packet or the packet. In this case, the information of the outer header includes the length of the outer header and the protocol type.

For example, the deletion unit 15a incorporates a proxy header including the length of the outer header and the protocol type into the inner packet. Alternatively, the deletion unit 15a adds Trailer including the length of the outer header and the protocol type to the end of the packet.

In addition, when the transfer device 10 receives a packet from the NSF, the addition unit 15b re-encapsulates the received packet and transfers the packet to another network device via the network N (step S2). At that time, the addition unit 15b adds an outer header to the packet by using information of the outer header extracted from the field. In this manner, a series of transfer processing ends.

Otherwise, the deletion unit 15a causes the storage unit 14 to store the information associating the packet with information of the inner packet when deleting the outer header of the encapsulated packet. In this case, when re-encapsulating the received packet, the addition unit 15b adds the outer header to the packet extracted from the storage unit by using the information of the associated inner packet. In this case, the information of the inner packet is any one of the 5-tuple, the hash values of the inner packet, and the hash value of a predetermined bit string in the inner packet.

Alternatively, the deletion unit 15a causes the storage unit 14 to store the information associating the outer header with information of the inner packet when deleting the outer header of the encapsulated packet. In this case, when re-encapsulating the received packet, the addition unit 15b adds the outer header associated with the information of the inner packet extracted from the storage unit 14. In this case, the information of the inner packet is any one of the hash value of the inner packet, and the hash value of a predetermined bit string in the inner packet.

### [Effect of Transfer Processing]

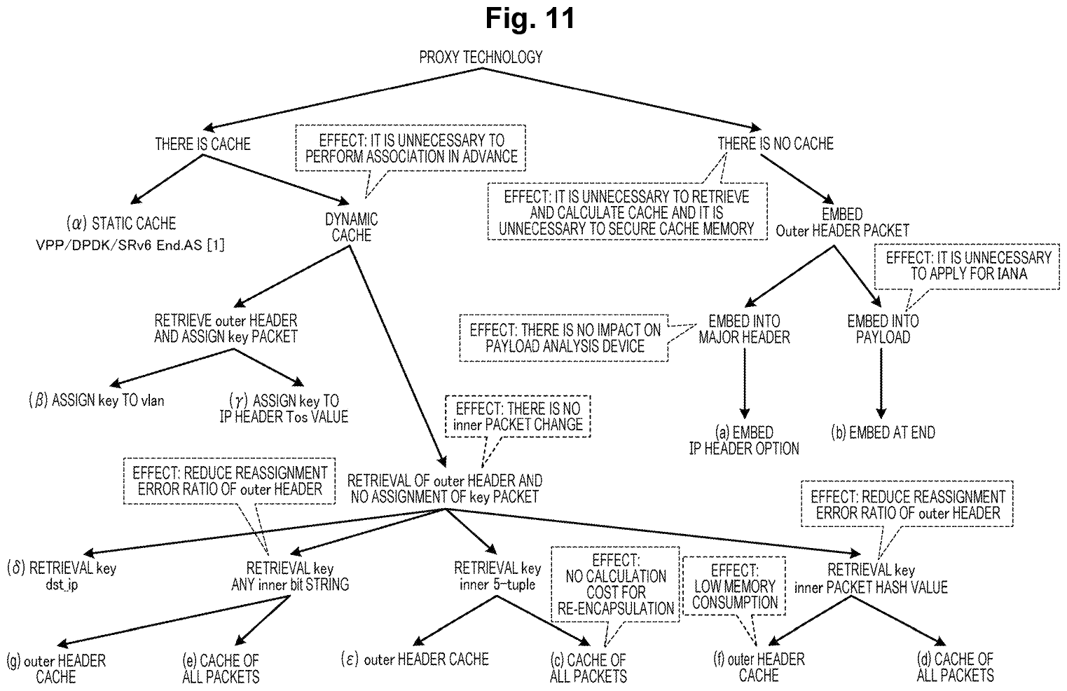

Next, FIG. 11 is a diagram for explaining an effect of transfer processing. As illustrated in FIG. 11(a), in the conventional static cache, it is necessary to associate the outer header and the inner header in advance. On the other hand, in the dynamic cache, as illustrated in FIGS. 11(β) and 11(γ), in the method of assigning a retrieval key of the outer header to a ToS value of a vlan header or an IP-header, the vlan-packet or the inner packet changes, which affects the service.

In addition, in the method in which a retrieval key of the outer header is not assigned, as illustrated in FIG. 11(δ), when a destination IP is used as the retrieval key, in a case where the inner packet is a local address such as ds-lite, a reassignment error of the outer header may occur. In addition, as illustrated in FIG. 11(ε), even when the 5-tuple of the inner packet is used as a retrieval key, similarly, in a case where the inner packet is a local address such as ds-lite, a reassignment error of the outer header may occur. Therefore, when the outer header is cached, there is a problem that the processing cost for re-encapsulation is increased. In the first place, in the method of performing caching, it is necessary to secure a cache memory.

On the other hand, in the transfer device 10 of the present embodiment, the deletion unit 15a provides the outer header and a field containing information of the outer header in the packet when deleting the outer header of the encapsulated packet. In addition, when re-encapsulating the received packet, the addition unit 15b adds an outer header to the packet by using information of the outer header extracted from the field. In this case, the information of the outer header includes the length of the outer header and the protocol type.

Specifically, in the transfer device, as illustrated in FIGS. 11(a) and 11(b), an outer header and a field containing the information of the outer header are provided in the packet without caching the packet or the outer header when deleting the outer header of the packet. For example, as illustrated in FIG. 11(a), by embedding the proxy header indicating the information of the outer header and the outer header in the inner packet, the transfer device 10 can easily perform re-encapsulation without affecting payload analysis. Furthermore, as illustrated in FIG. 11(b), by embedding Trailer indicating information of the outer header and the outer header at the end of the payload, the transfer device 10 can perform re-encapsulation without using the IRNA that manages the Internet resources.

Otherwise, in the transfer device 10, the deletion unit 15a causes the storage unit 14 to store the information associating the packet with information of the inner packet when deleting the outer header of the encapsulated packet. In this case, when re-encapsulating the received packet, the addition unit 15b adds the outer header to the packet extracted from the storage unit 14 by using the information of the associated inner packet. In this case, the information of the inner packet is any one of the 5-tuple, the hash values of the inner packet, and the hash value of a predetermined bit string in the inner packet.

Specifically, in the transfer device 10, as illustrated in FIGS. 11(c), 11(d), and 11(e), the information associating the packet with the information of the inner packet is stored in the storage unit when deleting the outer header of the packet. For example, as illustrated in FIG. 11(c), by associating the packet with the 5-tuple of the inner packet, the transfer device 10 can delete the processing cost of re-encapsulation. In addition, as illustrated in FIG. 11(d), by associating the packet with the hash value of the inner packet, the transfer device 10 can reduce the reassignment error of the outer header. In addition, as illustrated in FIG. 11(e), by associating the packet with the hash value of a predetermined bit string in the inner packet, the transfer device 10 can reduce the reassignment error of the outer header.

Alternatively, in the transfer device 10, the deletion unit 15a causes the storage unit 14 to store the information associating the outer header with information of the inner packet when deleting the outer header of the encapsulated packet. In this case, when re-encapsulating the received packet, the addition unit 15b adds the outer header associated with the information of the inner packet extracted from the storage unit 14. In this case, the information of the inner packet is any one of the hash value of the inner packet, and the hash value of a predetermined bit string in the inner packet.

Specifically, as illustrated in FIGS. 11(f) and 11(g), the transfer device 10 stores information associating the outer header with the information of the inner packet in the storage unit 14. For example, as illustrated in FIG. 11(f), by associating the outer header with the hash value of the inner packet, the transfer device 10 can reduce the memory consumption. In addition, as illustrated in FIG. 11(g), by associating the outer header with the hash value of a predetermined bit string in the inner packet, the transfer device 10 can reduce the reassignment error of the outer header.

As described above, according to the transfer processing of the transfer device 10 of the embodiment, processing such as packet analysis can be performed by the aggregated NSF at low cost.

### [Program]

It is also possible to produce a program that describes, in a computer executable language, the processing executed by the transfer device 10 according to the above embodiment. In an embodiment, the transfer device 10 can be implemented by installing a transfer program for executing the above transfer processing as packaged software or online software in a desired computer. For example, by causing an information processing apparatus to execute the transfer program, the information processing apparatus can be caused to function as the transfer device 10. Further, the information processing apparatus includes mobile communication terminals such as a smartphone, a mobile phone, and a personal handyphone system (PHS) and further includes a slate terminal such as a personal digital assistant (PDA). Further, the functions of the transfer device 10 may be implemented in a cloud server.

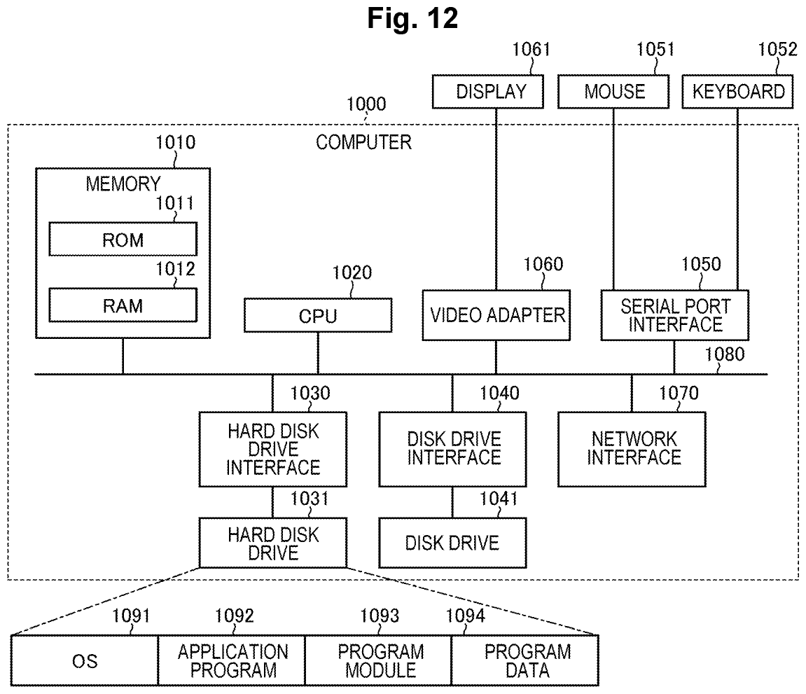

FIG. 12 is a diagram illustrating an example of a computer that executes the transfer program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. All of the information described in the above embodiment is stored in the hard disk drive 1031 or the memory 1010, for example.

In addition, the transfer program is stored in the hard disk drive 1031 as a program module 1093 in which commands to be executed by the computer 1000, for example, are described. Specifically, the program module 1093 in which all of the processing executed by the transfer device described in the above embodiment is described is stored in the hard disk drive 1031.

Further, data used for information processing performed by the transfer program is stored as program data 1094 in the hard disk drive 1031, for example. Then, the CPU 1020 reads, in the RAM 1012, the program module 1093 and the program data 1094 stored in the hard disk drive 1031 as needed and executes each procedure described above.

Note that the program module 1093 and the program data 1094 related to the transfer program are not limited to being stored in the hard disk drive 1031, and may be stored in, for example, a removable storage medium and read by the CPU 1020 via a disk drive 1041 or the like. Alternatively, the program module 1093 and the program data 1094 related to the transfer program may be stored in another computer connected via a network such as a local area network (LAN) or a wide area network (WAN) and may be read by the CPU 1020 via the network interface 1070.

Although the embodiments to which the invention made by the present inventor is applied have been described above, the present invention is not limited by the description and drawings constituting a part of the disclosure of the present invention according to the present embodiments. In other words, other embodiments, examples, operation techniques, and the like made by those skilled in the art and the like on the basis of the present embodiments are all included in the scope of the present invention.

### REFERENCE SIGNS LIST

10 Transfer device
13 Communication control unit
14 Storage unit
15 Control unit
15a Deletion unit
15b Addition unit

1. A transfer device comprising a processor configured to perform operations comprising:
providing an outer header and a field containing information of the outer header in an encapsulated packet when deleting the outer header of the packet; and
adding the outer header to a received packet by using information of the outer header extracted from the field when the packet is re-encapsulated.

2. The transfer device according to claim 1,
wherein the information of the outer header includes a length of the outer header and a protocol type.

3. A transfer device comprising a processor configured to perform operations comprising:
causing a memory to store information associating an encapsulated packet with information of an inner packet when deleting the outer header of the packet; and
adding the outer header to a received packet extracted from the memory by using the associated information of the inner packet when re-encapsulating the packet.

4. The transfer device according to claim 3, wherein the information of the inner packet is any one of a 5-tuple, a hash value of the inner packet, and a hash value of a predetermined bit string in the inner packet.

5. (canceled)

6. (canceled)

7. A transfer method executed by a transfer device, the method comprising:
providing an outer header and a field containing information of the outer header in an encapsulated packet when deleting the outer header of the packet; and
adding the outer header to a received packet by using information of the outer header extracted from the field when the packet is re-encapsulated.

8. (canceled)
